(19) United States
(12) Patent Application Publication
(10) Pub. No.: US 2020/0046596 A1
(43) Pub. Date: Feb. 13, 2020

(54) SKIN SUCTION HEAD AND SUCTION APPARATUS HAVING THE SAME

(71) Applicants: Kazuhiro Fujisawa, Okayama (JP); FOUR-LEAF CO., LTD., Okayama (JP)

(72) Inventor: Kazuhiro Fujisawa, Okayama (JP)

(21) Appl. No.: 16/310,513

(22) PCT Filed: May 2, 2017
(86) PCT No.: PCT/JP17/17274

§ 371 Date: Dec. 17, 2018

(51) Int. Cl. A61H 7/00

(52) U.S. Cl. CPC A61H 7/00; A61H 2201/5043; A61H 2201/5023; A61H 2201/1207

(57) ABSTRACT

A skin suction head (20) for sucking a skin includes: a flat main body (21); a distal end head portion (22) that is provided at a front end of the main body (21) and is brought into contact with the skin; a suction port (23) that is formed at the distal end head portion (22); and a connecting tube (24) that is provided at a rear end of the main body (21), in which the main body (21) is formed in a hollow shape such that air sucked from the suction port (23) flows toward the connecting tube (24), the distal end head portion (23) is elongate to be in contact with the skin over a wide area, and the suction port (23) is formed in a slit shape.

### TECHNICAL FIELD

The present disclosure relates to a skin suction head used for treatment, beauty care, or massage, for example, and a suction apparatus provided with the same.

### BACKGROUND

There is known an apparatus for performing treatment or massage while pressing a suction head against the skin and sucking the skin. For example, a suction massage probe disclosed in Patent Literature 1 applies mechanical vibration, in addition to massaging a body using exhaust suction, to further improve the massage effect, thereby allowing enhancement of the metabolism of tissues in the body and promotion of activation. A massaging machine disclosed in Patent Literature 2 is configured to instantly switch pulsated pressurized air and reduced-pressure air to massage stiff spots by the kneading effect through repeated sucking and pressing actions, thereby promoting blood flow through capillaries and enhancing the massaging effect while kneading the stiff spots.

### CITATION LIST

### Patent Literature

Patent Literature 1: Japanese Utility Model Laid-Open No. 3039531

Patent Literature 2: Japanese Patent Application Laid-open No. 2005-342456

### SUMMARY

In the suction massage probe disclosed in Patent Literature 1, a cap body 12 contacting the skin is formed into a cup shape (see FIG. 1 and paragraph [0012] in Patent Literature 1), and in the massaging machine disclosed in Patent Literature 2, a treating portion 2 contacting the skin is formed into a cylindrical shape or a rectangular tubular shape (see FIG. 1 and FIG. 4 in Patent Literature 2). In these structures, since an opening in a portion contacting the skin has a shape extending over the entire circumference with respect to the center, an operation for appropriately turning the head is additionally required to suck the target portion evenly, resulting in the training being required.

The present disclosure has been made to solve the above-described conventional problems, and an object thereof is to provide a skin suction head enabling effective treatment, or the like without requiring training, and a suction apparatus provided with the same.

In order to achieve the above-described object, a skin suction head of the present disclosure is a skin suction head for sucking a skin, including: a flat main body; a distal end head portion that is provided at a front end of the main body and is brought into contact with the skin; a suction port that is formed at the distal end head portion; and a connecting tube that is provided at a rear end of the main body, wherein the main body is formed in a hollow shape such that air sucked from the suction port flows toward the connecting tube, the distal end head portion is elongate to be in contact with the skin over a wide area, and the suction port is formed in a slit shape.

In the skin suction head of the present disclosure, the skin suction head is preferably used for treatment, beauty care, or massage.

A suction apparatus of the present disclosure is a suction apparatus provided with the skin suction head of the present disclosure, the apparatus including: a suction hose that is connected to the connecting tube of the skin suction head; and an operation panel that is connected to the suction hose.

According to the skin suction head of the present disclosure, even suction over the large area can be achieved, the target portion can be evenly sucked regardless of the level of training, and the treatment time can be reduced. A narrow width of the suction port enables the suction limited to just a target portion, thereby allowing enhancement of the suction effect. The narrow width of the suction port is not suitable for the strong suction but can create the negative pressure in the region directly under the distal end head portion, and thus the treatment for the skin, and the like can be performed; moreover, congestion of the skin can be prevented, and the connective tissue of the skin can be prevented from being damaged. A flexibility in usage of the skin suction head can be enhanced because a contact portion of the skin with the distal end head portion changes only by turning the skin suction head around the connecting tube. The distal end head portion can be planarly or linearly moved on the skin by moving the distal end head portion in parallel to the skin. This makes a variation in the treatment and the like without requiring training, and thereby the skin suction head can be easily used as appropriate depending on the target portion.

### BRIEF DESCRIPTION OF THE DRAWINGS

FIG. 1 is an overall perspective view of a suction apparatus according to one embodiment of the present disclosure;

FIG. 2 is an overall perspective view of a skin suction head according to one embodiment of the present disclosure;

FIG. 3 is a front view of the skin suction head according to one embodiment of the present disclosure;

FIG. 4 is a perspective view illustrating a state of use of the skin suction head according to one embodiment of the present disclosure;

FIG. 5 is a longitudinal cross-sectional view illustrating part of the skin suction head and a skin illustrated in FIG. 4; and

FIG. 6 is a perspective view illustrating another application example of the skin suction head according to one embodiment of the present disclosure.

### DETAILED DESCRIPTION OF THE EMBODIMENTS

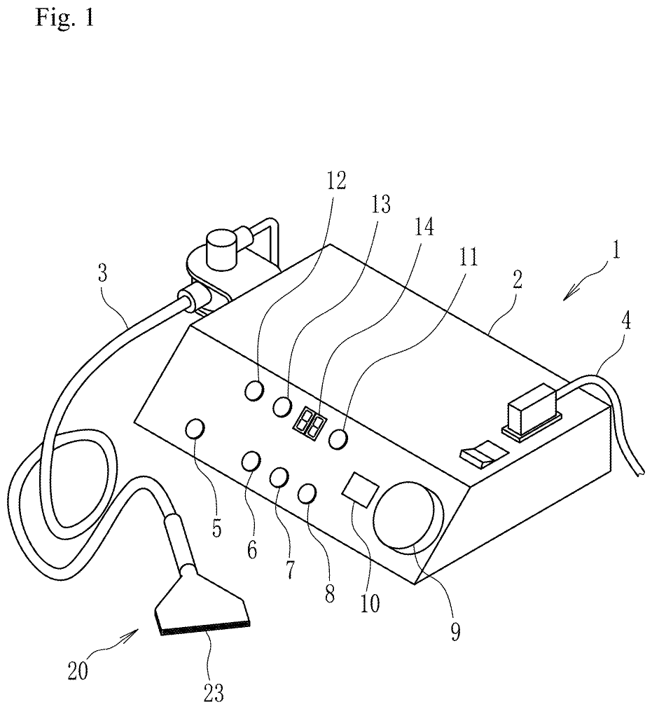

Hereinafter, one embodiment of the present disclosure will be described with reference to the drawings. First of all, an overview of a suction apparatus 1 according to one embodiment of the present disclosure will be described with reference to FIG. 1. FIG. 1 is an overall perspective view of the suction apparatus 1 according to the present embodiment. A suction hose 3 is connected to an operation panel 2, and a skin suction head 20 is connected to a distal end of the suction hose 3. A power cord 4 is connected to the operation panel 2, and a power switch 5 is turned on and off to switch a state of the suction apparatus 1 between operation and stop. An electric pump (not illustrated) is built in the suction apparatus 1, and when the electric pump is driven, air is sucked from a suction port 23 provided at a distal end of the skin suction head 20 and is discharged through the suction hose 3.

Suction mode selection buttons 6 to 8 are used to be able to switch a suction force to a desired one of three different levels of low, middle and high suction modes. In each suction mode, a suction adjustment dial 9 is turned to enable the suction force to be further adjusted. The suction force is displayed on a suction force display panel 10. The suction force can be reset by pressing a suction force reset button 11.

The suction apparatus 1 has a timer function, and a time-up button 12 is pressed to extend the setting time, and a time-down button 13 is pressed to reduce the setting time. The setting time of the timer is displayed on a timer display panel 14.

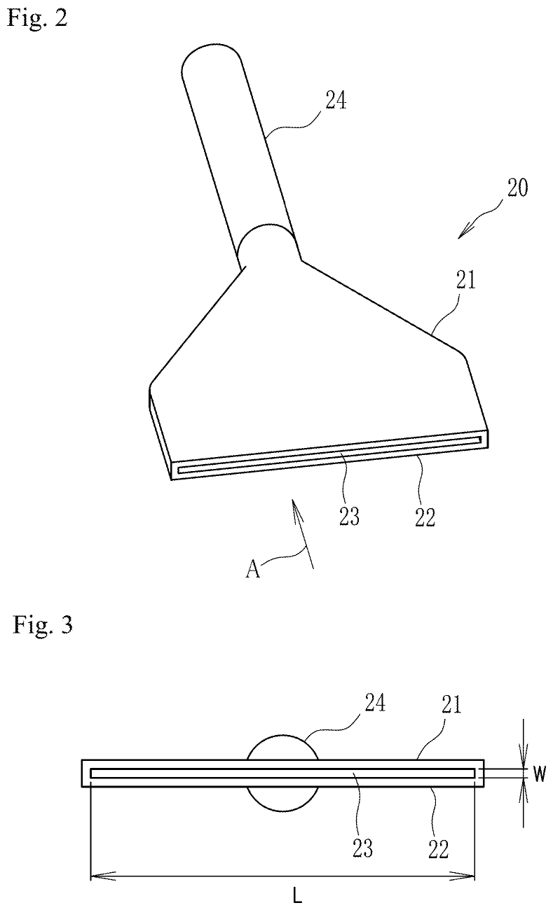

FIG. 2 is an overall perspective view of the skin suction head 20 illustrated in FIG. 1, and FIG. 3 is a front view (seen from an arrow A in FIG. 2) of the skin suction head 20 illustrated in FIG. 2. The skin suction head 20 is comprised of a flat main body 21 as a main part, a distal end head portion 22 is provided at a front end of the main body 21, and a connecting tube 24 is provided at a rear end of the main body 21. The distal end head portion 22 is a portion which is to be brought into contact with the skin, and is elongate to be in contact with the skin over a wide area. The suction port 23 having a slit shape is formed on the distal end head portion 22.

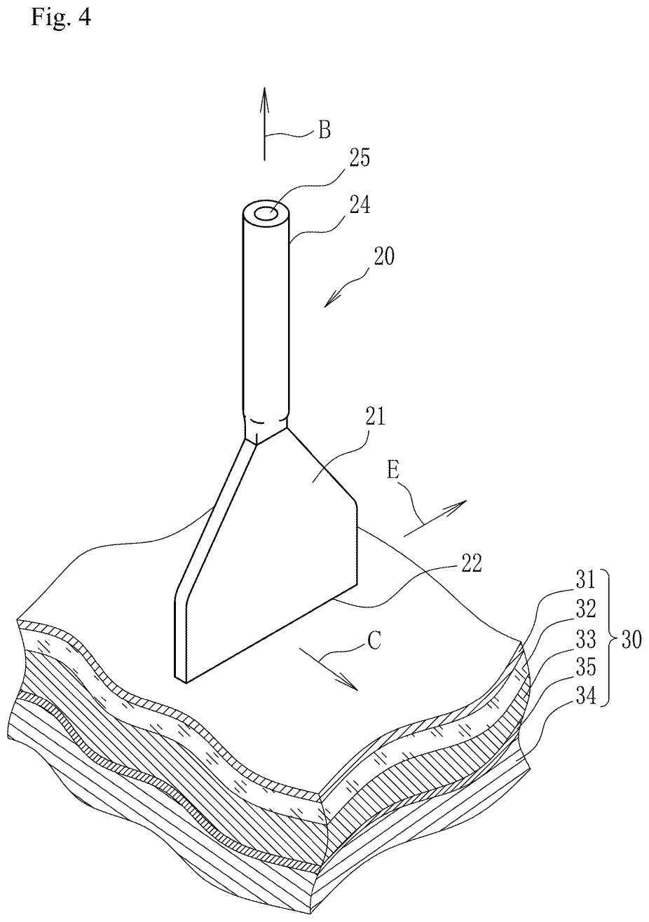

The main body 21 is formed in a hollow shape such that air sucked from the suction port 23 flows toward the connecting tube 24. More specifically, the air sucked from the suction port 23 passes through a hollow portion in the main body 21, and an opening 25 (see FIG. 4) formed at an end of the connecting tube 24, and then into the suction hose 3 (see FIG. 1).

FIG. 4 is a perspective view illustrating a state of use of the skin suction head 20. For convenience, FIG. 4 illustrates the skin suction head 20 as a single body, and the illustration of the suction hose 3 is omitted. The skin suction head 20 according to the present embodiment is used for suction of the skin, so that the effect on stimulating the connective tissue comprising the skin can be achieved by the suction of the skin. Therefore, the skin suction head 20 is suitable for treatment, beauty care, or massage, for example. More specifically, sucking the skin helps to solve problems about adhesion and sliding failure of the connective tissue, thereby allowing alleviation of pains caused by acute injuries such as muscle strain and sprain, chronic pains such as stiff shoulder and lumbago, and pains caused by sports injuries, and daily physical disorder, stress and physical posture.

The present inventors have studied therapy for the skin, and will describe the points on which the present inventors focused regarding the suction of the skin to derive the present embodiment, with reference to a schematic diagram of a skin structure in FIG. 4 before describing the present embodiment more specifically. As illustrated in FIG. 4, a skin 30 consists of three layers: an epidermis 31 at the outermost layer, a dermis 32, and a subcutis 33 (subcutaneous fat), and a muscle 34 is located under the skin 30 and is enclosed by a fascia 35. The epidermis 31 is about 0.2 mm in thickness, the dermis 32 is about 2 to 3 mm in thickness, the subcutis 33 is about 4 to 9 mm in thickness, and the total thickness of the three layers is about 1 cm.

The joint mobility is transmitted to the brain not through the intraarticular receptor but through the skin, and the intraarticular receptor only fires at the start and end of the joint movement. Various receptors are concentrated within a range of on the order of 0.2 mm to 2 mm from the epidermis 31. About 200 to 400 polymodal receptors are present per square meter, and pressure-sensitive Pacinian corpuscles and Meissner's corpuscles, heat-sensitive Ruffini corpuscles and free nerve endings, cold-sensitive Krause corpuscles and free nerve endings, tactile Pacinian corpuscles and Meissner's corpuscles, pain-sensitive free nerve endings, and the like are distributed up to about the subcutis 33.

The above-described polymodal receptors are called pain sensors, and predominantly present under the epidermis 31. Pooling the water such as lymphatic fluid may stimulate nerves and cause the body pain. The body's fluid containing lymphatic fluid is also present in the epidermis 31 and on a surface of the subcutis 33 directly below the dermis 32.

As described above, irritation to the body in the skin suction treatment does not need to reach up to a deep portion of the body, and it is understood that the irritation only needs to reach the skin portion. It is believed that this applies also to beauty care, or massage for the skin, because the beauty care or massage is applied to the skin.

The present inventors have found that under such an assumption, the skin suction head 20 (see FIG. 2) with the distal end head portion 22 being elongate and the suction port 23 having a slit shape can achieve various effects as described below, and enables effective treatment, or the like without requiring training, and accordingly has a structure suitable for the treatment for the skin, and the like. Hereinafter, specific description will be made.

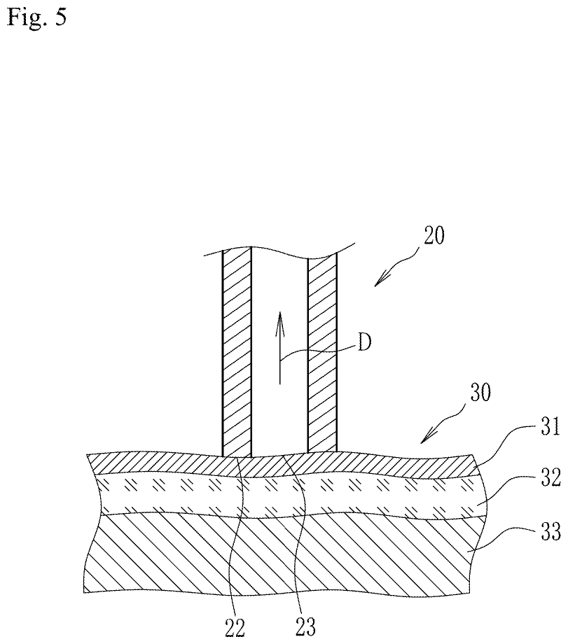

FIG. 5 is a longitudinal cross-sectional view illustrating a part of the skin suction head 20 of FIG. 4, and the cross-sectional view also illustrates a part of the skin 30. Air in the vicinity of the skin 30 is sucked toward the suction hose 3 (see FIG. 1) through the skin suction head 20 (arrow D). This suction can create negative pressure in the region directly under the distal end head portion 22. As described above, the irritation to the body in the treatment for the skin does not need to reach a deep portion of the body, only needs to reach the skin portion, and strong suction force is not required for an instrument to be used. Accordingly, as in the present embodiment, if the negative pressure can be created in the region directly under the distal end head portion 22, the treatment for the skin, and the like can be performed.

On the other hand, as described above, the distal end head portion 22 is elongate, and the suction port 23 is formed in a slit shape, resulting in the width of the suction port 23 becoming narrower. Therefore, the skin 30 can be prevented from being drawn upward due to the suction, congestion of the skin can be prevented, and the connective tissue of the skin can be prevented from being damaged. In other words, the narrow width of the suction port 23 is not suitable for the strong suction but, as described above, can create negative pressure in the region directly under the distal end head portion 22, and thus the treatment for the skin, and the like can be performed; moreover, congestion of the skin can be prevented, and the connective tissue of the skin can be prevented from being damaged. Furthermore, the narrow width of the suction port 23 enables the suction limited to just a target portion, thereby allowing enhancement of the suction effect.

As illustrated in FIG. 4, the skin suction head 20 brings the distal end head portion 22 into contact with the skin 30 and is placed on the skin 30 to be perpendicular to the skin 30. In this state, the skin suction head 20 can be used while moving the distal end head portion 22 parallel to the skin 30 (in a direction of an arrow C). In this case, the distal end head portion 22 is elongate, and the suction port 23 is formed in a slit shape (see FIG. 2 and FIG. 3), resulting in an area of contact of the distal end head portion 22 with the skin 30 being larger, and a suction area by the suction port 23 being also larger.

Thus, one suction port 23 can be brought into contact with the skin 30 over a large area, thereby enabling even suction over the large area. This can also provide a patient with feel as if an operation were performed by a human hand, and can achieve the relaxation effect releasing the psychosomatic tension.

The above-described operation is simple because the skin suction head 20 can be operated only by moving the distal end head portion 22 parallel to the skin 30, thereby allowing even suction of the target portion regardless of the level of training. This also leads to the reduction in treatment time. On the other hand, if a cylindrical head is used, for example, an operation for appropriately turning the head is additionally required to achieve the same effect as above, resulting in the training being required and the treatment time being also extended.

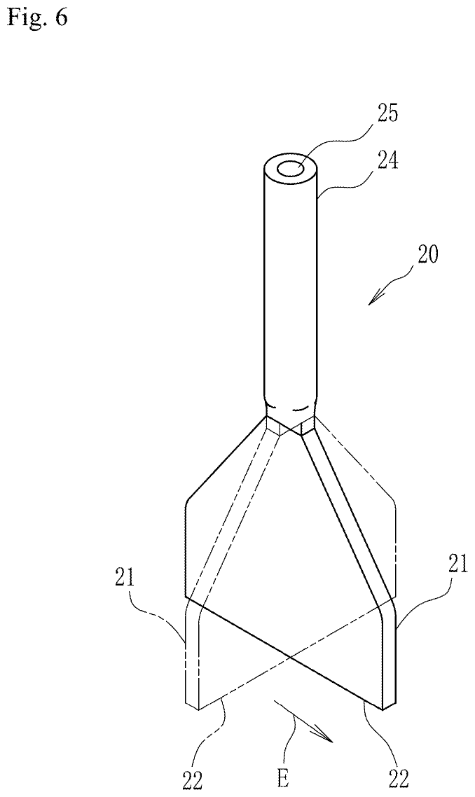

FIG. 6 is a perspective view illustrating another application example of the skin suction head 20. FIG. 4 illustrates an example in which the skin suction head 20 is used by moving the distal end head portion 22 parallel to the skin 30, but the present disclosure is not limited to this application example. A flexibility in usage of the skin suction head 20 can be enhanced because a contact portion of the skin 30 with the distal end head portion 22 changes only by turning the skin suction head 20 around the connecting tube 24. FIG. 6 illustrates states before and after the skin suction head 20 is turned around the connecting tube 24 by 90 degrees.

In the example of FIG. 4, the distal end head portion 22 can be planarly moved on the skin 30 (see an arrow C) by moving the distal end head portion 22 parallel to the skin 30, but in the example of FIG. 5, the distal end head portion 22 can be linearly moved on the skin 30 (not illustrated in FIG. 6) (see an arrow E). This also applies to the case where the distal end head portion 22 is laterally moved in FIG. 4 (see an arrow E). This makes a variation in the treatment and the like without requiring training, and thereby the skin suction head 20 can be easily used as appropriate depending on the target portion. For example, the distal end head portion 22 can be pressed against the skin 30 to correspond to elongated grooves of an intermuscular septum, thereby allowing relaxation of the intermuscular septum portion efficiently.

Hereinbefore, one embodiment of the present disclosure has been described, but the size of the suction port 23 is not limited to a particular size. For example, in FIG. 3, a width W is preferably within a range from 1 mm to 5 mm, and more preferably within a range from 2 mm to 3 mm. For example, a length L may be within a range from 2 cm to 10 cm. The width W and the length L may be changed depending on the target portion. The material and manufacturing method of the skin suction head 20 are not limited to particular material and manufacturing method. The material may be metal or resin, and if the metal is used, the flat main body 21 may be formed by welding peripheries of metal plates facing each other, and the connecting tube 24 may be welded and fixed to the main body 21.

### REFERENCE SIGNS LIST

1 Suction apparatus

2 Operation panel

3 Suction hose

20 Skin suction head

21 Main body

22 Distal end head portion

23 Suction port

24 Connecting tube

30 Skin

What is claimed is:

1. A skin suction head for sucking a skin, comprising:
a flat main body;
a distal end head portion that is provided at a front end of the main body and is brought into contact with the skin;
a suction port that is formed at the distal end head portion; and
a connecting tube that is provided at a rear end of the main body, wherein
the main body is formed in a hollow shape such that air sucked from the suction port flows toward the connecting tube, and
the distal end head portion is elongate to be in contact with the skin over a wide area, and the suction port is formed in a slit shape.

2. The skin suction head according to claim 1, wherein the skin suction head is used for treatment, beauty care, or massage.

3. A suction apparatus provided with the skin suction head according to claim 1, comprising: a suction hose that is connected to the connecting tube of the skin suction head; and an operation panel that is connected to the suction hose.
